(19) United States
(12) Patent Application Publication
(10) Pub. No.: US 2018/0222595 A1
(43) Pub. Date: Aug. 9, 2018

(54) AIRCRAFT ENGINE PYLON WITH INBUILT MULTIFUNCTIONAL FRAMEWORK

(71) Applicant: SOGECLAIR SA, Blagnac (FR)

(72) Inventor: Jean Paul GIAVARINI, Castelnau D'Estretefonds (FR)

(73) Assignee: SOGECLAIR SA, Blagnac (FR)

(21) Appl. No.: 15/750,527

(22) PCT Filed: Jul. 20, 2016
(86) PCT No.: PCT/EP2016/067266

§ 371 Date: Feb. 6, 2018

(30) Foreign Application Priority Data
Aug. 12, 2015 (FR) 1557700

(51) Int. Cl. B64D 27/26

(52) U.S. Cl. CPC B64D 27/26; B64D 2027/264

(57) ABSTRACT

The invention seeks to get around the problems of mass and complexity of pylons made up of assembled box sections. In order to do so, the invention effectively proposes organizing the engine-wing interface around a substantially uniform framework configured to incorporate the multiple functions (transmission, safety) and house the pylon equipment (extinguishers, heat exchanger etc.). This framework forms a structural assembly capable of transmitting load and of forming an aerodynamic fairing suited to this framework. A pylon according to the invention comprises a single structural and multifunctional framework (10) made up of main canals (11; 11a to 11e) housing equipment and transmission systems (41a to 41c) between the engine and the wing structure, and a latticework (20) of arms (12) and of nodes (13) connecting the arms together. These arms (12) and/or canals (11; 11a to 11e) being able to attach fairing cowls (14) to form an aerodynamic fairing with a configuration that is predetermined by a pre-established positioning of the arms (12) and of the canals (11; 11a to 11e).

### CROSS REFERENCE TO RELATED APPLICATION

This application is a national stage entry of PCT/EP2016/067266 filed Jul. 20, 2016, under the International Convention claiming priority over French Patent Application No. 1557700 filed Aug. 12, 2015.

### TECHNICAL FIELD

The invention relates to an aircraft pylon intended to attach an engine rigidly to the wing or to the fuselage of an aircraft by suspending or otherwise attaching it, this pylon having an integrated multifunctional framework structure.

The invention concerns the interface between an engine and the rest of equipment of any type of industrial product, in particular in the aeronautical and aerospace fields where optimizing mass and production cycles are essential conditions.

### BACKGROUND OF THE INVENTION

In the avionics field, this connection is a pylon that connects any type of engine, in particular a turbojet or a turboprop engine. FIG. 1 and its enlargement (FIG. 1A) at the level of the pylon 1 and the turbojet 3 show the position of a conventional pylon 1 of an aircraft 100 between a wing 2 and the turbojet 3 of that aircraft 100. The pylon 1 is equipped with a system for connecting it to the wing 2 and to the turbojet 3 by central and rear attachments respectively at the rear level of a fan cowling 3s and at the level of a turbine cowling 3t.

As shown in the FIG. 2 front view, a pylon 1 conventionally consists of an assembly comprising a plurality of structures: a primary central rigid structure 4C surrounded by secondary aerodynamic structures—a front structure 4A and a rear structure 4B—on either side of a fairing 4K for connecting it to the wing 2 (termed a Karman fairing, the location of which is shown in dashed outline) and a lower aerodynamic fairing 4F disposed under both the primary structure 4C and the rear aerodynamic structure 4B. Also seen in this figure are the attachments that attach the pylon to the wing and to the cowlings of the turbojet, namely the attachments 2c, 2r and 2m, 2n, respectively.

The mechanical assembly of a pylon consists of several hundred components assembled into basic structures intended to absorb mechanical loads or to convey fluids whilst addressing weight and production cycle objectives.

The aircraft pylon structures form a complex member with a very high level of constraints because of the engine environment with its multiple functions that need to be satisfied, notably: aerodynamic, structural, thrust absorption, transmission of electrical wiring systems, fuel, hydraulic and pneumatic lines between the engine and the wing via appropriate pipes.

These structures usually consist of box sections formed by assembling upper and lower stringers connected by attached side fairing panels stiffened by transverse ribs. These box sections are designed to transmit to the wing static and dynamic forces generated by the engines: mass, thrust, dynamic forces, vibrations.

However, the assembly of such structures—generally fastened together by bolts and rivets—suffers numerous mechanical disadvantages linked to the large number of components and therefore to the complexity of such an assembly: vibration, expansion, mass, aerodynamics, transmission of more numerous systems, etc., while engines are ever larger and heavier.

A large number of improvements have been proposed to solve these problems.

For example, it is known from patent document US 2012/080554 to add shear pins to the front wing attachments to absorb forces exerted in the longitudinal, transverse and vertical directions of the pylon.

To reduce the flexing of the side front attachment fittings to the wing patent document EP 2 426 051 proposes equipping a central front attachment with a ball-joint aligned transversely with first orifices of the side front attachments.

In patent document U.S. Pat. No. 8,366,039 the front attachment is flexible in order to absorb deformations of the front fairing components caused in particular by fan blade strikes.

Moreover, in document U.S. Pat. No. 8,336,813 the rear lower part of the pylon is curved in the direction of the root of the corresponding wing in order to deflect the aerodynamic flow and to compensate local lift variations caused by the presence of the pylon.

To limit aerodynamic drag and therefore to reduce fuel consumption patent document EP 2 030 892 proposes an articulation between two parts of the pylon attached to a cowling of the engine and to the aircraft wing, which makes it possible to move the engine away from the wing in the cruising phase and to move them closer together—and thus to move the engine away from the ground—in the take-off or landing phase.

In the solution described in document U.S. Pat. No. 6,838,955 progressive widening of the pylon in its rear part and mounting junction elements in the rear attachment make it possible to increase the distance between those junction elements and therefore to transmit substantially higher forces. Thus heavier and more powerful engines can be mounted in place of those originally intended for a given wing.

Other solutions provide additional means: bearings, actuators, hydraulic pistons, links, etc. in order to oppose longitudinal flexing of the engine or to improve the absorbing of thrust forces (cf. in particular documents EP 1 571 080, EP 1 571 081 and EP 1 571 082).

Also, document US 20120104/62 describes an aircraft pylon including means for rigid attachment to the engine and to the wing with a duct for equipment and transmission systems and a separate framework. And document FR 2 931 133 discloses an aircraft pylon with ducts for equipment and transmission systems, these ducts being on each side of a box section of the pylon. Finally document US 20110121132 shows another pylon including a framework with no housing for equipment and transmission systems between the engine and the wing.

Such assemblies increase the number of parts and therefore the overall mass and remain structurally complex. The constituent box sections therefore remain of difficult and restricted access, which does not allow easy access to the internal members. Moreover the structure of these assemblies does not take direct account of constraints in respect of installation, maintenance and production, constraints linked to variations of pressure and temperature, or the requirements of safety regulations (recovery of leaks, etc.).

All these constraints therefore lead to installing circuits necessitating connections inside the structures (with risks of leaks) and dedicated area drainage and sealing systems.

Moreover, air circuits installed in the pylons comprise intake pipes for cold air and hot air that converge inside the pylon toward a heat exchanger. These pipes are separate from and attached to the structures. The temperature difference between these various pipes and the receiving structure can be several hundred degrees Celsius. This results in problems of differential expansion that cannot be solved simply and effectively.

### SUMMARY OF THE INVENTION

The invention aims to overcome the problems arising in the prior art, in particular those linked to the complexity and the mass of the pylons, as well as satisfying aerodynamic requirements, through an approach going resolutely against that consisting in assembling an aircraft pylon from dedicated box sections and connecting the resulting assembly to the engine and to the wing by means of dedicated attachments. Indeed the invention proposes to organize the engine-wing interface around a substantially homogeneous framework configured to integrate multiple functions (via circuit and pipe systems) and to protect the pylon equipment (extinguishers, heat exchanger, etc.). This framework forms a structural assembly enabling transmission of forces and formation of an appropriate aerodynamic fairing for this framework.

To this end, the present invention consists in an aircraft pylon adapted to serve as an interface between an engine and an aircraft wing or fuselage by means of rigid attachment to the engine and to the wing of the aircraft. This pylon includes a single multifunctional structural framework formed of main ducts receiving equipment and transmission systems between the engine and the wing or the fuselage and a latticework of arms and nodes connecting the arms, these arms and/or ducts being adapted to attach fairing panels. By a predefined positioning of the arms and the ducts panels attached in this way form an aerodynamic fairing with a predetermined conformation.

Under these conditions, partitions between the various structures of the pylons are eliminated and the panels, which are no longer structural, are then easily demountable: this simplifies access to equipment—extinguishers, heat exchanger—and systems—electrical wiring, hydraulic circuits, fuel and air supply circuits, etc.—and installation constraints are therefore relaxed through the adaptability of the connecting latticework forming the framework, whist favoring a significant reduction in overall mass.

Moreover, these circuits form an integral part of the framework, which eliminates installation problems, the use of connectors and therefore the associated risks of leaks. Moreover, integrating the hot and cold air circuits into the framework eliminates the possibility of differential expansion because the framework consists of only one material.

According to preferred embodiments:

the framework is of a metal alloy chosen from a stainless steel containing at least 10% nickel and an alloy based mainly on nickel and chromium, for example “INCONEL” alloys also containing iron, molybdenum, niobium and cobalt; these alloys are able to withstand temperatures and/or engine powers above and beyond the current highest values;

the framework is produced by a technology selected from welding, molding and/or 3D printing (i.e. printing “in three dimensions”, this technology also being known as “additive layer manufacturing”);

the framework is produced either in one piece by the application of a molding or 3D printing technology or as a plurality of parts produced by molding and/or 3D printing and welded and/or glued together;

at least one of the transmission systems is integrated into the ducts in accordance with a double-skin structure;

the panels are attached to the arms and/or to the ducts of the framework by demountable mechanical means.

In the present text, the modifiers “upper” and “lower” relate to a configuration suspending the engine under the wing in standard use. In configurations with the engine above the wing these modifiers would be reversed, of course. Moreover, the location terms “front”, “rear” and the like are to be understood according to a standard use of the aircraft in its usual motion in flight. The modifier “side” relates to a view in a plane parallel to the central plane of symmetry extending longitudinally on the axis of an aircraft.

### BRIEF DESCRIPTION OF THE FIGURES

Other data, features and advantages of the present invention will become apparent on reading the following nonlimiting description with reference to the appended figures, which show:

FIGS. 1, 1A and 2, views of a conventional aircraft pylon (already commented on) respectively located between a turbojet and an aircraft wing, enlarged above the turbojet and in a side view;

FIGS. 3 and 4, side and top views of an example of an integrated framework pylon according to the invention;

FIG. 5, a diagram of a double-skin pipe for hydraulic flow and fuel supply; and

FIG. 6, a view of circuits integrated into this example of a pylon according to the invention.

### DETAILED DESCRIPTION

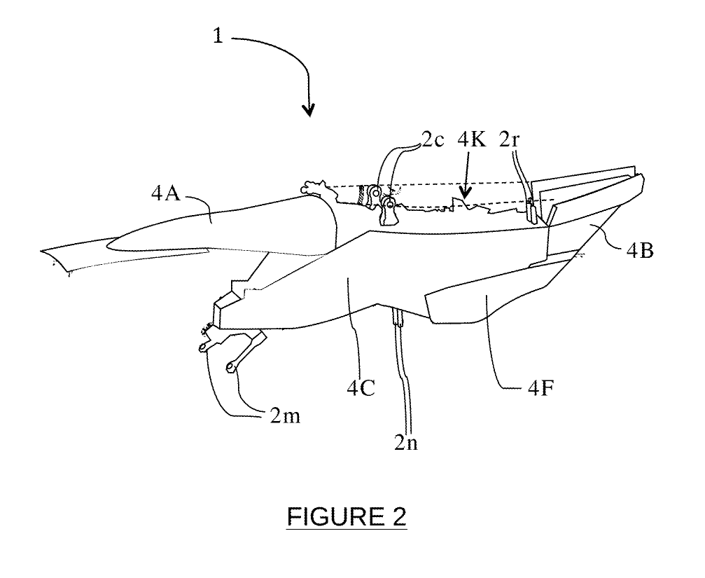

Referring to the side and top views of FIGS. 3 and 4, showing one example of an integrated framework pylon 10 according to the invention produced in this example by application of the 3D technology, there are seen main ducts 11, namely ducts 11a to 11c, connected by arms 12 forming a connecting latticework 20. The arms 12 connect the ducts 11 together and cross at nodes 13 for stiffening the whole of the framework 10.

Non-structural panels 14 are attached by demountable means—bolts, clips, flanges or the like—to the arms 12 of the latticework 20 and to the ducts 11. A portion of the panels 14 is not shown in FIGS. 3 and 4 in order to enable the pylon framework 10 to be seen, the framework 10 being entirely covered by panels 14 when installed on an aircraft wing. And the set of panels forms a fairing the aerodynamics of which are controlled by the conformation that results from the relative positioning of the ducts 11 and the arms 12 of the latticework 20.

Walls 31 of the framework 10 advantageously form a thermally insulative housing 30 for a heat exchanger (not shown). As a general rule thermally and/or electrically insulative walls—forming an integral part of the framework—can be provided between the ducts and latticework arms to constitute housings, for example for an extinguisher or other equipment.

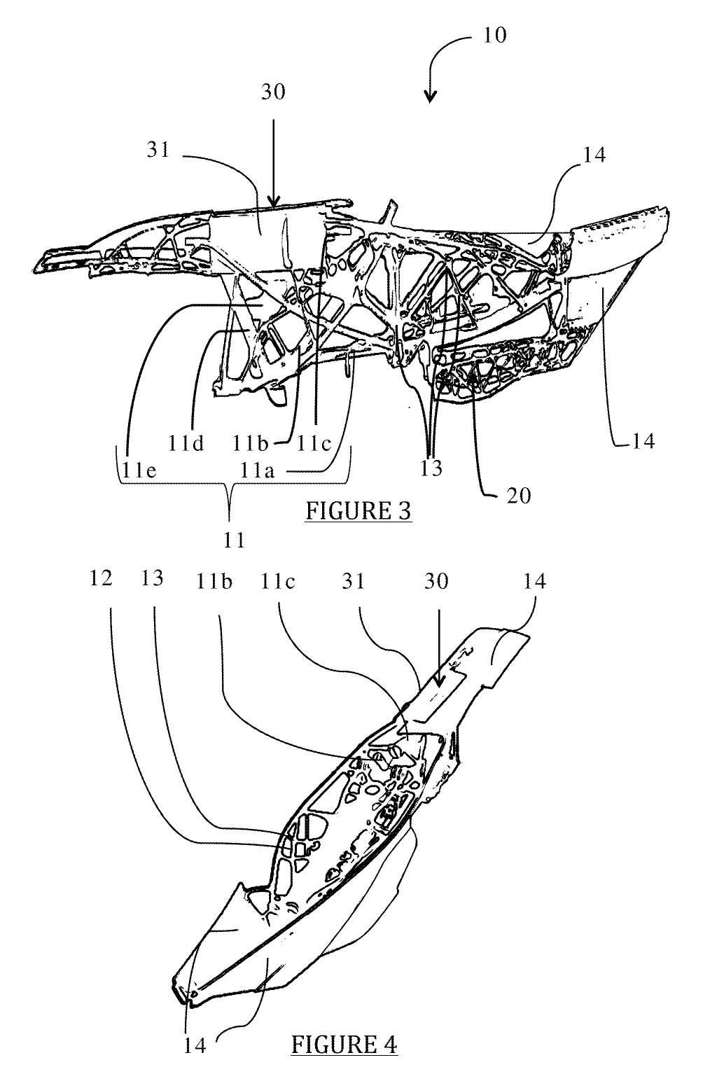

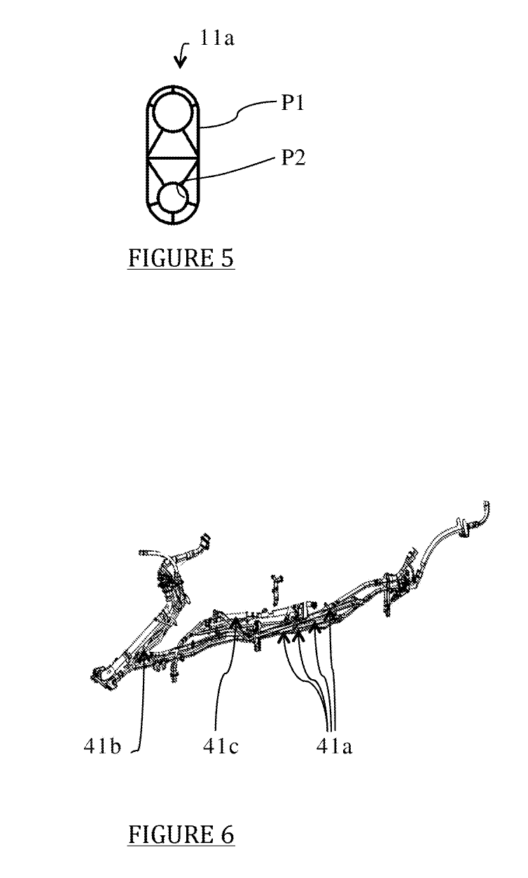

With more particular reference to the ducts, a duct 11a with double skins P1 and P2, as shown in the FIG. 5 diagram, receives circuits, for example hydraulic pipes or a fuel supply circuit (cf. FIG. 6). The ducts 11d and 11e also receive air pipes for cabin air conditioning.

The FIG. 6 side view shows hydraulic pipes 41a-advantageously configured in homogeneous layers—, a fuel circuit 41b and an extinguisher pipe 41c to be respectively integrated into the ducts 11a, 11b and 11c of the pylon framework 10 according to the invention (cf. FIGS. 4 and 5). These ducts are sized and configured to receive these circuits and pipes directly.

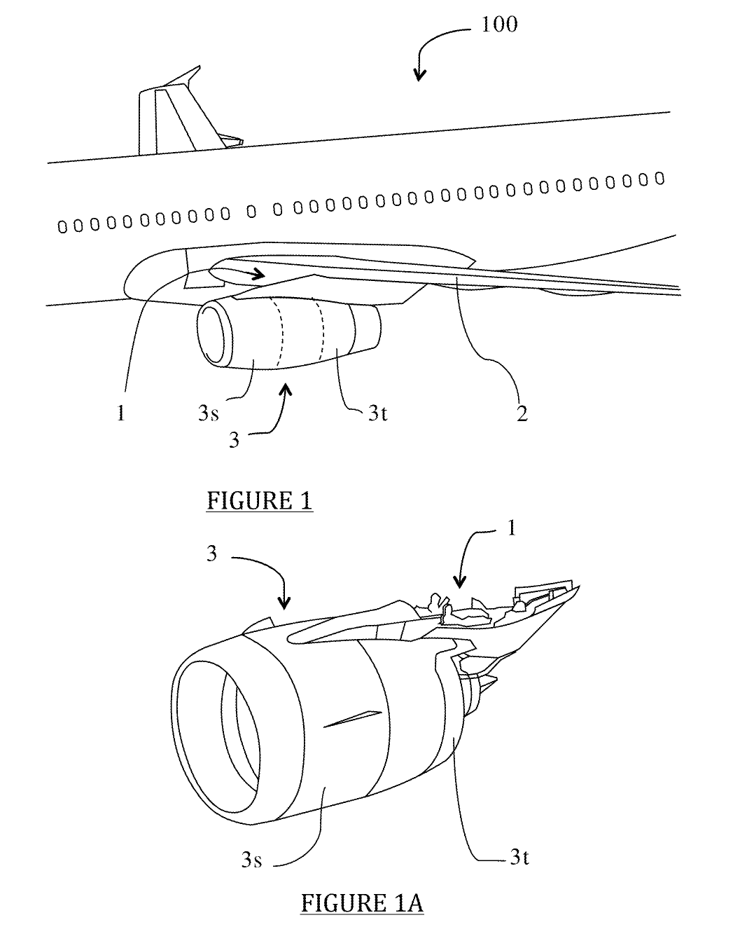

In particular, the fuel circuit 41b is integrated into the double-skin duct 11b, the conformation of the airtight external skin being governed by the structural strength and aerodynamic constraints of the framework 10 whilst conforming to the inside diameters, geometries and interfaces on the side of the wing 2 and on the side of the engine 3 (cf. FIG. 1).

The invention is not limited to the embodiments described and shown. Accordingly the sizing of the framework advantageously integrates additional constraints linked to the temperature gradient between the wing and the engine. Moreover, the material used to produce the framework according to the invention can be a stainless steel containing nickel or an alloy based mainly on nickel and chromium, such as the “INCONEL” 625 or 718 alloy also containing iron, molybdenum, niobium and cobalt.

As an alternative to attaching the pylon under the wing of an aircraft, in equivalent embodiments the pylon can be attached directly to a fuselage or on top of the wing of an aircraft.

Moreover, the framework can be produced in one piece or as a plurality of parts fastened together by welding, gluing or any other means for fastening together an assembly of this kind. The basic technology used is 3D printing and/or molding.

Moreover, the attachments of a pylon with a framework according to the invention to the wing and the engine are again those used in the pylons with a multiple box section structure described with reference to FIGS. 1A and 2.

Also, the arm density in the latticework is substantially constant in the framework but can have a higher value in some parts of the pylon, for example to form a lower rear fairing.

1. An aircraft pylon adapted to serve as an interface between an engine and an aircraft wing or fuselage by of rigid attachment to the engine and to the wing of the aircraft, the aircraft pylon comprising:
a single multifunctional structural framework formed of main ducts receiving equipment and transmission systems between the engine and the wing or the fuselage; and
a latticework of arms and nodes connecting the arms, the arms and/or ducts being adapted to attach fairing panels to form an aerodynamic fairing in accordance with a predetermined conformation by a predefined positioning of the arms and the ducts.

2. The aircraft pylon as claimed in claim 1, wherein the framework is of a metal alloy chosen from a stainless steel containing at least 10% nickel and an alloy based mainly on nickel and chromium.

3. The aircraft pylon as claimed in claim 1, wherein the framework is produced by a technology selected from welding, molding, and/or 3D printing.

4. The aircraft pylon as claimed in claim 1, wherein the framework is produced either in one piece by the application of a molding or 3D printing technology or as a plurality of parts produced by molding and/or 3D printing and welded and/or glued together.

5. The aircraft pylon as claimed in claim 1, in which at least one of the transmission systems is integrated into the ducts in accordance with a double-skin structure.

6. The aircraft pylon as claimed in claim 1, wherein the panels are attached to the arms and/or to the ducts of the framework by demountable mechanical device.
